(19) United States
(12) Patent Application Publication
(10) Pub. No.: US 2024/0425701 A1
(43) Pub. Date: Dec. 26, 2024

(54) PROCESS FOR PRODUCING A BINDER FOR AN ASPHALT COMPOSITION

(71) Applicant: Stora Enso OYJ, Helsinki (FI)

(72) Inventors: Heikki Lotti, Stockholm (SE); Jesper Ekström, Johanneshov (SE); Dimitri Areskogh, Bromma (SE)

(73) Assignee: Stora Enso OYJ, Helsinki (FI)

(21) Appl. No.: 18/701,004

(22) PCT Filed: Nov. 8, 2022
(86) PCT No.: PCT/IB2022/060726

§ 371 Date: Apr. 12, 2024

(30) Foreign Application Priority Data
Nov. 11, 2021 (SE) 2151383-3
Jul. 12, 2022 (SE) 2230238-4

(51) Int. Cl. C08L 95/00; C08H 7/00

(52) U.S. Cl. CPC C08L 95/00; C08H 6/00; C08L 2555/82

(57) ABSTRACT

The present invention is directed to a process for preparing a binder for an asphalt composition. The binder comprises lignin, a renewable and bio-based material, which replaces part of the fossil-based bitumen.

### FIELD OF THE INVENTION

The present invention is directed to a process for preparing a binder for an asphalt composition. The binder comprises lignin, a renewable and bio-based material, which replaces part of the fossil-based bitumen.

### BACKGROUND

Asphalt is generally prepared by mixing aggregate and filler materials with a bitumen-based binder. Bitumen is derived from the heaviest portion from the oil distillation process. It may have different properties due to the different origins of the oil as well as due to the different distillation processes employed. Bitumen can be characterized by the presence of four classes of substances each having different molecular weight ranges: saturates, aromatics, resins, and asphaltenes.

Since bitumen is obtained from fossil sources that are non-renewable, there is a desire to at least partly replace it by renewable and sustainable bio-based alternatives.

Therefore, bio-based alternatives for bitumen are widely sought after for the manufacturing of asphalt and bitumen emulsions. As reported by some earlier patent literature e.g. EP2918640A1 and WO2019/092278, lignins have been identified as suitable additives and replacements for the conventional bitumen and polymeric bitumen in asphalt.

However, handling of lignin with an increased moisture content and a wide distribution of particle sizes presents several issues. Among those is the inhomogeneous blending with bitumen. As a consequence, a poor distribution of the lignin in the lignin-bitumen matrix is achieved which will have detrimental impact on the final asphalt composition.

Thus, there is a need for a process for preparing binders for asphalt compositions or asphalt compositions that uses a form of lignin (or lignin containing material) that enables a well dispersed and homogenous distribution over the entire matrix.

### SUMMARY OF THE INVENTION

The present invention provides a solution to several of the problems of the prior art. A particular advantage of the process according to the present invention is that the wide distribution of particles in the lignin is significantly narrowed which enables a uniform and homogeneous distribution of lignin. The present invention also provides such an improved binder composition

Thus, the present invention is directed to a process for preparing an asphalt composition or a binder for an asphalt composition, comprising the steps of
a) providing a lignin material having a solid content of lignin in the range of from 30 wt-% to 95 wt-%, calculated based on the total weight of the material;
b) reducing the overall particle size of the lignin material of step a) by means of crushing, milling or disintegration; and
c) mixing the material from step b) with a bitumen blend to obtain a binder for an asphalt composition or mixing the material from step b) with an asphalt blend to obtain an asphalt composition.

The present invention is also directed to a binder for an asphalt composition prepared using the process according to the present invention. The present invention is also directed to an asphalt composition prepared according to the present invention.

### DETAILED DESCRIPTION

It is intended throughout the present description that the expression “lignin” embraces any kind of lignin, e.g. lignin originated from hardwood, softwood or annual plants. Preferably the lignin is an alkaline lignin generated in e.g. the Kraft process. Preferably, the lignin has been purified or isolated before being used in the process according to the present invention. The lignin may be isolated from black liquor and optionally be further purified before being used in the process according to the present invention. The purification is typically such that the purity of the lignin is at least 90%, preferably at least 95%, more preferably at least 98%, most preferably at least 99%, 99.5% or 99.9%. Thus, the lignin used according to the process of the present invention preferably contains less than 10%, preferably less than 5%, more preferably less than 2% impurities. The lignin may then be separated from the black liquor by using the process disclosed in WO2006031175.

The reactivity of the lignin can be increased by modifying the lignin by glyoxylation, etherification, esterification or any other method where lignin hydroxyl content or carboxylic content or amine content or thiol content is increased. Preferably, the lignin used according to the present invention is not modified chemically.

According to the present invention, the lignin material used has a solid content of lignin in the range of from 30 wt-% to 95 wt-%, calculated based on the total weight of the material. Preferably, the solid content is in the range of from 40 wt-% to 80 wt-%, calculated based on the total weight of the material. More preferably, the solid content is in the range of from 50 wt-% to 80 wt-%, calculated based on the total weight of the material. Preferably, the aqueous content of the material has a pH in the range of from 1 to 9, preferably 2 to 7 or 6 to 7 or 2 to 5. The material used preferably comprises lignin that has been separated from black liquor generated in the Kraft process. Preferably, the lignin has been separated from the black liquor using the Lignoboost or Lignoforce process.

The lignin material used in the process according to the present invention is subjected to a milling, grinding and/or crushing operation, to reduce the overall particle size distribution prior to mixing with the bitumen blend or asphalt blend. Optionally, the lignin in the slurry or the slurry has also been subjected to sieving. The sieving may take place before or after the milling, grinding and/or crushing operation, preferably after the milling, grinding and/or crushing operation. Preferably, the material contains less than 10 wt-%, calculated based on the dry weight of the lignin, of lignin agglomerates or particles having a diameter larger than 15 mm. More preferably, the material contains less than 5 wt-%, calculated based on the dry weight of the lignin, of lignin agglomerates or particles having a diameter larger than 15 mm. Even more preferably, the material contains less than 5 wt-%, calculated based on the dry weight of the lignin, of lignin agglomerates or particles having a diameter larger than 10 mm. Most preferably, the material contains less than 5 wt-%, calculated based on the dry weight of the lignin, of lignin agglomerates or particles having a diameter larger than 5 mm.

The milling, grinding and/or crushing can for example be carried out by means of a rotary granulator, cage mill, beater mill, hammer mill or crusher mill and/or combinations thereof.

If the lignin has been subjected to sieving, also referred to as screening, that typically involves screening by means of physical fractionation to obtain a final product which may be a material comprising lignin with a defined particle size distribution set by the porosity of the sieves or screens in this step. By using a screening stage with two or more different screen porosities, several fractions with more defined particle size distribution may be obtained.

In one embodiment of the present invention, the milling, grinding and/or crushing is carried out at an asphalt plant. Thus, lignin can be transported to the asphalt plant in the form of a lignin material having a solid content of lignin in the range of from 30 wt-% to 95 wt-%. The lignin may then be subjected to milling, grinding and/or crushing, preferably at the same location at which the lignin is mixed with the bitumen blend or asphalt blend. A particular advantage is that the handling of the lignin is significantly simplified when the lignin is transported.

The bitumen blend used according to the present invention comprises bitumen and optionally for example vegetable oil.

The bitumen used in the bitumen blend, with which the lignin material is mixed, is derived from the heaviest portion from the oil distillation process. It may have different properties due to the different origins of the oil as well as due to the different distillation processes employed. However, bitumen can be characterized by the presence of four classes of substances each having different molecular weight ranges: saturates, aromatics, resins, and asphaltenes. The bitumen in the bitumen blend used according to the present invention may be selected from virgin bitumen, recycled bitumen, or mixtures thereof. In the bitumen blend, the bitumen may be present in an amount of at least 1, 10, 15, 20, 25, 30, 40, 50, 60, 70, 80, 90, 100 wt. % and/or at most 300, 250, 200, 180, 150, 125, 110 wt. %, preferably 80-120 wt. % with respect to the weight of the disintegrated lignin. The lignin preferably replaces 40-60 wt-% of the bitumen.

The bitumen blend may also comprise other components. For example, the bitumen blend may comprise vegetable oil, or non-fossil derived oil, preferably chosen from linseed oil, soybean oil, sunflower oil, and safflower oil. Preferably, the vegetable oil has a dynamic viscosity of 0.01-1600 Pa·s at 20° C. or 0.01-1000, 0.03-500, or 0.05-250, preferably 0.1-100, 0.2-50, 0.3-20, 0.4-10, 0.5-5 or 0.5-2 Pa·s at 20° C. Kinematic viscosity may be determined by using an Ubbelohde viscometer according to ASTM D 445 or its equivalent BS 188. The dynamic viscosity can be calculated from the kinematic viscosity data by multiplying the latter by the density.

As used herein, the term “asphalt blend” refers to a blend comprising aggregates and optionally a binder, such as bitumen. The asphalt may be or comprise reclaimed asphalt pavement.

As used herein, the term “asphalt composition” refers to the composition obtained by the method according to the present invention.

To obtain an asphalt composition, the binder is mixed with aggregates, such as sand, stone and/or rubble. Typically, the asphalt composition comprises about 60-90 wt-% aggregates. According to the present invention, the amount of lignin in the asphalt composition is preferably in the range of from 1 wt-% to 12 wt-%, preferably from 2 wt-% to 7 wt-%.

The lignin can be mixed with the bitumen blend and the mixture of lignin and the bitumen blend is then mixed with the stone aggregates. Alternatively, the bitumen blend may first be mixed with the stone aggregates and the lignin can then be added to the mixture of the bitumen blend and the stone aggregates. Alternatively, the lignin can be added to the stone aggregates in the asphalt blending step prior the dosing of bitumen. In this embodiment, the lignin is preferably added to the aggregates in its agglomerated form. The disintegration of the lignin agglomerates preferably takes place during mixing with the aggregates, wherein the aggregates may also comprise fibers and/or other fillers. During the mixing, the agglomerated lignin becomes disintegrated. A particular benefit of this embodiment is that a separate disintegration step wherein the lignin agglomerates are disintegrated can be avoided and the process for preparing the asphalt composition can be simplified, still achieving the benefit of obtaining an improved binder composition in which lignin is well dispersed and homogenously distributed. Alternatively, the lignin can be added to reclaimed asphalt pavement prior to it being mixed with asphalt blend.

The asphalt composition can be used for example as a pavement or road paving.

Advantageously, the use of lignin which has been subjected to milling, grinding, crushing and/or sieving, a favourable particle size distribution is obtained that facilitates obtaining a homogenous distribution of lignin in the bitumen blend or asphalt blend is achieved.

In view of the above detailed description of the present invention, other modifications and variations will become apparent to those skilled in the art. However, it should be apparent that such other modifications and variations may be effected without departing from the spirit and scope of the invention.

1. A process for preparing an asphalt composition or a binder for an asphalt composition, comprising the steps of
a) providing a lignin material having a solid content of lignin in a range of from 30 wt-% to 95 wt-%, calculated based on a total weight of the lignin material;
b) reducing an overall particle size of the lignin material of step a) by crushing, milling, or disintegration; and
c) mixing the lignin material from step b) with a bitumen blend to obtain a binder for an asphalt composition or mixing the lignin material from step b) with an asphalt blend to obtain an asphalt composition.

2. The process according to claim 1, wherein the lignin material has been subjected to sieving before or after step b).

3. The process according to claim 1, wherein the solid content of the lignin material used in step a) is in a range of from 40 wt-% to 80 wt-%.

4. The process according to claim 4, wherein the solid content of the lignin material used in step a) is in a range of from 50 wt-% to 75 wt-%.

5. The process according to claim 1, wherein an aqueous content of the lignin material used in step a) has a pH in a range of from 1 to 7.

6. A binder for an asphalt composition produced by the process according to claim 1.

7. An asphalt composition produced by the process according to claim 1.

8. A pavement or road paving comprising:
the asphalt composition according to claim 7.
